(19) United States
(12) Patent Application Publication
(10) Pub. No.: US 2020/0398986 A1
(43) Pub. Date: Dec. 24, 2020

(54) SYSTEMS FOR STORAGE AND DEPLOYMENT OF AN AERIAL DRONE

(71) Applicant: GM GLOBAL TECHNOLOGY OPERATIONS LLC, Detroit, MI (US)

(72) Inventors: Joel G. Toner, Imlay City, MI (US); Teresa J. Rinker, Royal Oak, MI (US); Prachi Joshi, Troy, MI (US); Niccolo Jimenez, Royal Oak, MI (US); Jinzhu Chen, Troy, MI (US); Fan Xu, Oakland Township, MI (US); Daniel Bouie, Sunnyville, CA (US)

(73) Assignee: GM GLOBAL TECHNOLOGY OPERATIONS LLC, Detroit, MI (US)

(21) Appl. No.: 16/450,222

(22) Filed: Jun. 24, 2019

(51) Int. Cl. B64D 1/02; B64C 39/02; B64C 9/02; B64D 3/00

(52) U.S. Cl. CPC B64D 1/02; B64C 39/02; B64C 2201/208; B64D 3/00; B64C 9/02

(57) ABSTRACT

An exemplary system for storage and deployment of a drone from a vehicle includes a platform having a platform surface including a magnetic latching system configured to releasably secure the drone to the platform surface, a storage member enclosing the platform, the storage member defining a storage volume configured to enclose the drone when the drone is secured to the platform, an actuator configured to move the platform relative to the storage member, the platform movable between an enclosed position and an unenclosed position, and at least one controller in communication with the actuator, the at least one controller being configured to, in response to satisfaction of a first operating condition, control the actuator to move the platform to the unenclosed position, and, in response to satisfaction of a second operating condition, control the actuator to move the platform to the enclosed position.

The present disclosure relates generally to systems for storage and deployment of an aerial drone from an automotive vehicle.

The use of aerial drones for photography and surveillance is increasing. Often, aerial drones are deployed from a static location, such as a designated launching area.

### SUMMARY

Embodiments according to the present disclosure provide a number of advantages. For example, embodiments according to the present disclosure enable storage, charging, and deployment of a vehicle-deployed drone.

A system for storage and deployment of a drone from a vehicle according to the present disclosure includes a platform having a platform surface including a magnetic latching system configured to releasably secure the drone to the platform surface and a storage member enclosing the platform. The storage member defines a storage volume configured to enclose the drone when the drone is secured to the platform and unenclose the platform to permit launch of the drone from the platform. The system also includes an actuator configured to move the storage member between an enclosed position and an unenclosed position and at least one controller in communication with the actuator. The at least one controller is configured to, in response to satisfaction of a first operating condition, control the actuator to move the storage member to the unenclosed position, and, in response to satisfaction of a second operating condition, control the actuator to move the storage member to the enclosed position.

In an exemplary embodiment, the platform includes an inductive charging member to inductively charge the drone when the drone is secured to the platform surface.

In an exemplary embodiment, the storage member includes a cover member, the actuator is coupled to the cover member, and the at least one controller is configured to, in response to satisfaction of a first operating condition, control the actuator to move the cover member to the unenclosed position, and, in response to satisfaction of a second operating condition, control the actuator to move the cover member to the enclosed position.

In an exemplary embodiment, the system further includes a hinge coupled to the cover member and in communication with the actuator and the cover member rotates relative to the platform.

In an exemplary embodiment, the cover member translates relative to the platform.

In an exemplary embodiment, the storage member rotates relative to the platform.

In an exemplary embodiment, the magnetic latching system includes a magnetic latch in communication with the at least one controller, wherein the at least one controller is configured to, in response to satisfaction of the first operating condition, control the magnetic latch to release the drone from the platform surface and, in response to satisfaction of the second operating condition, secure the drone to the platform surface.

In an exemplary embodiment, the first operating condition comprises a drone launching instruction received by the controller and the second operating condition comprises a drone storage instruction received by the controller.

An exemplary system for storage and deployment of a drone from a vehicle, according to the present disclosure, includes a platform having a platform surface including a magnetic latching system configured to releasably secure the drone to the platform surface and a storage member enclosing the platform, the storage member defining a storage volume configured to enclose the drone when the drone is secured to the platform. The system also includes an actuator configured to move the platform relative to the storage member, the platform movable between an enclosed position and an unenclosed position and at least one controller in communication with the actuator. The at least one controller is configured to, in response to satisfaction of a first operating condition, control the actuator to move the platform to the unenclosed position, and, in response to satisfaction of a second operating condition, control the actuator to move the platform to the enclosed position.

In an exemplary embodiment, the storage member is a cylinder defining a cylindrical volume configured to enclose the drone when the drone is secured to the platform surface.

In an exemplary embodiment, the system further includes a cover member hingably coupled to the storage member.

In an exemplary embodiment, the platform is coupled to the storage member via a tether configured to unwind from the storage member to vertically extend the platform above the storage member and wind to pull the platform within the cylindrical volume of the storage member.

In an exemplary embodiment, the system further includes a hinge coupled to the actuator and to the platform such that the platform is rotatable about the hinge and in the unenclosed position, the platform is rotated 180 degrees from the enclosed position.

In an exemplary embodiment, the first operating condition includes a drone launching instruction received by the controller and the second operating condition includes a drone storage instruction received by the controller.

In an exemplary embodiment, the platform includes an inductive charging member to inductively charge the drone when the drone is secured to the platform surface.

In an exemplary embodiment, the magnetic latching system includes a magnetic latch in communication with the at least one controller, wherein the at least one controller is configured to, in response to satisfaction of the first operating condition, control the magnetic latch to release the drone from the platform surface and, in response to satisfaction of the second operating condition, secure the drone to the platform surface.

An automotive vehicle according to the present disclosure includes a vehicle body and a storage and deployment system for an aerial drone. The system includes a platform having a platform surface including a magnetic latch configured to releasably secure the drone to the platform surface and a storage member adjacent to the platform, the storage member defining a storage volume configured to enclose the drone when the drone is secured to the platform. The system also includes an actuator configured to move one of the storage member and the platform between an enclosed position and an unenclosed position and at least one controller in communication with the actuator. The at least one controller is configured to, in response to receipt of a drone launching instruction, control the actuator to move the storage and deployment system to the unenclosed position, and, in response to receipt of a drone storage instruction, control the actuator to move the storage and deployment system to the enclosed position.

In an exemplary embodiment, moving the storage and deployment system to the unenclosed position includes moving the storage member relative to the platform such that the platform is not enclosed by the storage member and moving the storage and deployment system to the enclosed position includes moving the storage member relative to the platform such that the platform is enclosed by the storage member.

In an exemplary embodiment, moving the storage and deployment system to the unenclosed position includes moving the platform relative to the storage member such that the platform is not enclosed by the storage member and moving the storage and deployment system to the enclosed position includes moving the platform relative to the storage member such that the platform is enclosed by the storage member.

In an exemplary embodiment, the platform includes an inductive charging member to inductively charge the drone when the drone is secured to the platform surface.

### BRIEF DESCRIPTION OF THE DRAWINGS

The present disclosure will be described in conjunction with the following figures, wherein like numerals denote like elements.

FIG. 1 is a side view of a storage and deployment system for a vehicle-deployed drone, according to an embodiment.

FIG. 2 is a side view of another storage and deployment system for a vehicle-deployed drone, according to an embodiment.

FIG. 3A is a top view of another storage and deployment system for a vehicle-deployed drone in a storage configuration, according to an embodiment.

FIG. 3B is a top view of the storage and deployment system of FIG. 3A in a deployed configuration, according to an embodiment.

FIG. 4A is a side view of another storage and deployment system for a vehicle-deployed drone in a storage configuration in a storage configuration, according to an embodiment.

FIG. 4B is a side view of the storage and deployment system of FIG. 4A in a deployed configuration, according to an embodiment.

FIG. 5 is a side view of another storage and deployment system for a vehicle-deployed drone in a storage configuration, according to an embodiment.

FIG. 6 is a side view of another storage and deployment system for a vehicle-deployed drone in a storage configuration, according to an embodiment.

FIG. 7 is a perspective view of another storage and deployment system for a vehicle-deployed drone in a storage configuration, according to an embodiment.

FIG. 8 is a schematic view of a charging system for a vehicle-deployed drone, according to an embodiment.

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through the use of the accompanying drawings. Any dimensions disclosed in the drawings or elsewhere herein are for the purpose of illustration only.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present disclosure. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Certain terminology may be used in the following description for the purpose of reference only, and thus are not intended to be limiting. For example, terms such as “above” and “below” refer to directions in the drawings to Which reference is made. Terms such as “front,” “back,” “left,” “right,” “rear,” and “side” describe the orientation and/or location of portions of the components or elements within a consistent but arbitrary frame of reference which is made clear by reference to the text and the associated drawings describing the components or elements under discussion. Moreover, terms such as “first,” “second,” “third,” and so on may be used to describe separate components. Such terminology may include the words specifically mentioned above, derivatives thereof, and words of similar import.

Embodiments disclosed herein provide systems for storing an aerial drone on a vehicle. The systems protect the drone, safely retain and secure the drone, and present the drone for safe and remote deployment. In various embodiments, the systems include inductive charging or contact charging to charge the drone when not in use. In various embodiments, the systems disclosed herein may be integrated with existing vehicle architecture or may be coupled to the vehicle as an add-on feature.

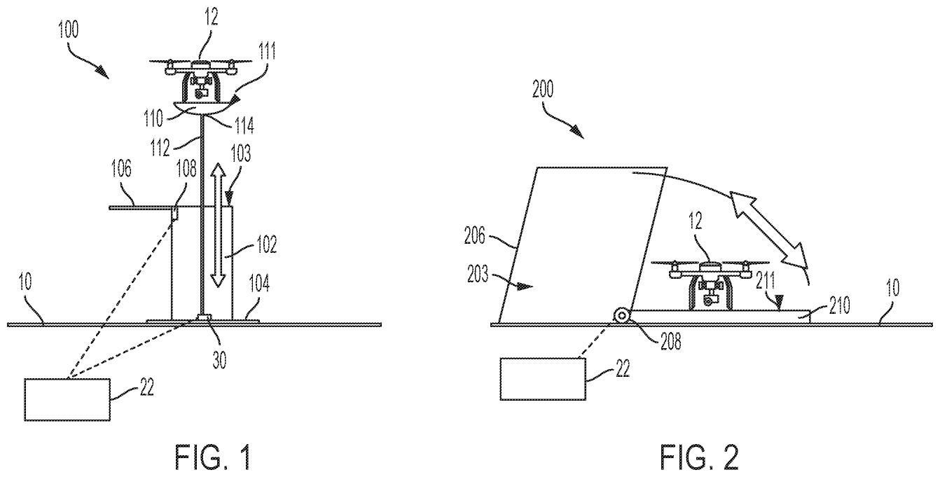

With reference to FIG. 1, a vehicle 10, a surface portion of which is depicted in FIG. 1, includes a storage and deployment system 100 for an aerial drone 12, according to an embodiment of the present disclosure. As used herein, the term “drone” refers to any application-suitable remotely piloted aircraft, e.g., unmanned aerial vehicle (“UAV”), unmanned aerial system (“UAS”), remotely-piloted aircraft system (“RPAS”), for example and without limitation. The storage and deployment system 100 is, in some embodiments, coupled to the vehicle 10 via any type of mechanical means (such as, for example and without limitation, screws, nuts, bolts, etc.) or chemical means (such as welding). In various embodiments, the storage and deployment system 100 is removably attached to the vehicle 10.

The storage and deployment system 100 includes a storage member 102. The storage member 102 is configured to enclose the drone 12. The storage member 102 can be any shape or size such that the drone 12 is removably contained within the storage member 102. As shown in FIG. 1, the storage member 102 is a cylinder defining a cylindrical volume 103 in which the drone 12 is removably stored. The storage member 102 is secured, either removably or fixedly, to a base 104. The base 104 may be separate from the vehicle 10 or may be integrated into the vehicle 10. A planar cover member 106 is rotatably secured to the storage member 102 via a hinge 108. The hinge 108 allows the cover member 106 to rotate away from the storage member 102 to uncover the cylindrical volume 103. In various embodiments, the hinge 108 is a hinged actuator. The cover member 106 may be configured to rotate away from the storage member 102 around either a longitudinal or lateral axis. In various embodiments, the cover member 106 and hinge 108 are integrally formed with the storage member 102.

The storage member 102 encloses a platform 110. The platform 110 includes a platform surface 111. In various embodiments, the platform surface 111 is an induction charging surface, as discussed in further detail herein. In some embodiments, the platform surface 111 is magnetically charged to engage with a magnetic member of the drone 12. In some embodiments, the platform surface 111 includes another retention means, such as releasable clips, etc., to releasably secure the drone 12 to the platform 110.

The platform 110 is connected to the storage member 102 via a tether 112. In various embodiments, the tether 112 is coupled to an actuator 30. In various embodiments, the actuator 30 is a linear actuator or a scissor lift system. The tether 112 may be unwound from the base of the storage member 102 to vertically extend the platform 110 above the storage member 102. The tether 112 may be wound to pull the platform 110 within the cylindrical volume 103. The tether 112 may be flexible, such as a cord or cable, or may be a foldable linkage member including a plurality of linked members.

In various embodiments, one or both of the hinge 108 and the tether 112 are in communication with or under the control of at least one controller 22. In various embodiments, one or both of the hinge 108 and the tether 112 are directly controlled by the controller 22 or via one or more actuators 30 in communication with the controller 22.

The controller 22 is enclosed within or in communication with the vehicle 10. While depicted as a single unit for illustrative purposes, the controller 22 may additionally include one or more other controllers, collectively referred to as a “controller.” The controller 22 may include a microprocessor or central processing unit (CPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 22 in controlling the vehicle.

Another embodiment of a storage and deployment system 200 for an aerial drone 12 is shown in FIG. 2. The system 200 includes a platform 210 coupled to the vehicle 10. Similar to the platform 110, the platform 210 includes a platform surface 211. In various embodiments, the platform surface 211 is an induction charging surface, as discussed in further detail herein. In some embodiments, the platform surface 211 is magnetically charged to engage with a magnetic member of the drone 12. In some embodiments, the platform surface 211 includes another retention means, such as releasable clips, etc., to releasably secure the drone 12 to the platform 210.

A cover member 206 is rotatably secured to the platform 210 via a hinge 208. The cover member 206 is an open-ended box defining a storage volume 203. Rotation of the cover member 206 around the hinge 208, as shown in FIG. 2 by the double-sided arrow, either encloses the drone 12 on the platform 210 or pivots away from the drone 12 to allow the drone 12 to safely deploy from the platform surface 211. In various embodiments, the hinge 208 is in communication with and actuatable by at least one controller 22, as discussed above with respect to the hinge 108. The controller 22 generates a control signal that is transmitted to the hinge 208 (or to an actuator coupled to the hinge 208) to rotate the cover member 206 open or closed, depending on whether the drone 12 is to be launched or covered. In various embodiments, the hinge 208 is a linear actuator or electric motor or is coupled to a linear actuator or electric motor, each of which is in communication with the controller 22. In various embodiments, the cover member 206 is secured to the platform surface 211 using an electric latch, which may be in communication with the controller 22.

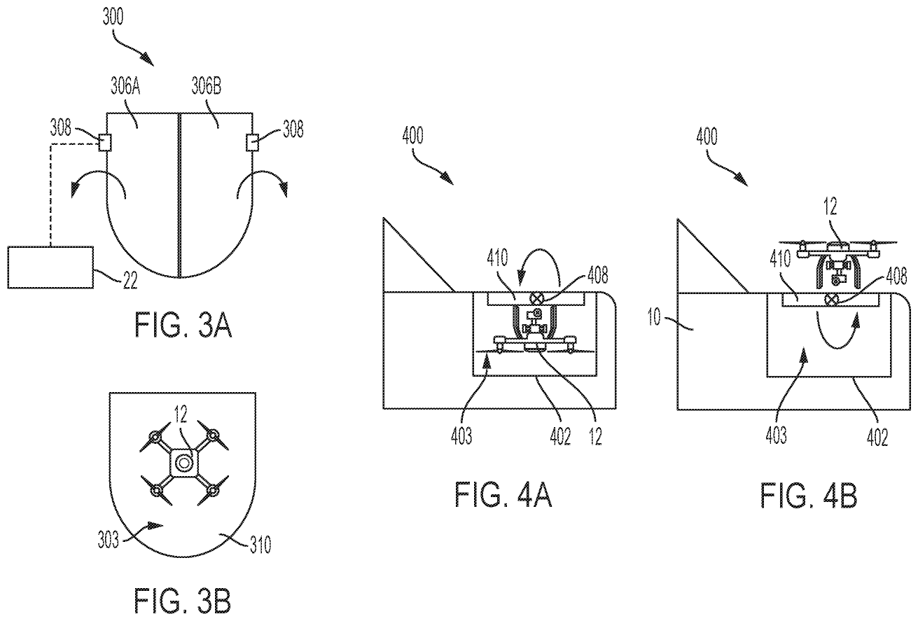

FIGS. 3A and 3B illustrate another embodiment of a storage and deployment system 300 for an aerial drone 12. In this embodiment, cover members 306A, 306B rotate about the hinges 308 similar to a clamshell opening. The cover members 306A, 306B enclose a storage volume 303 that may be disposed within the vehicle or mounted on an exterior surface of the vehicle. The drone 12 is secured to or rests on the platform 310. When the cover members 306A, 306B are open, the drone 12 may be deployed from the platform 310. In various embodiments, as discussed above, the hingers 308 are in communication with and actuatable by at least one controller 22. The system 300 may be permanently or removably coupled to a vehicle, such as the vehicle 10.

With reference to FIGS. 4A and 4B, another embodiment of a storage and deployment system 400 is illustrated. The system 400 includes a storage member 402 enclosed within the vehicle 10 and defining a storage volume 403. A platform 410 is rotatable about a hinge 408 to either enclose the drone 12 as shown in FIG. 4A or provide a launching platform for the drone 12 as shown in FIG. 4B. The transition of the platform 410 between the enclosed position shown in FIG. 4A to the unenclosed position shown in FIG. 4B is a result of 180-degree rotation of the platform 410 about the hinge 408. In various embodiments, the hinge 408 is mounted approximately near the center of the platform 410 such that the platform 410 rotates or “flips” around a centerline from the enclosed position to the unenclosed position and vice versa. In various embodiments, as discussed above, the hinge 408 is in communication with and actuatable by at least one controller, such as the controller 22. In various embodiments, the hinge 408 is an electric motor or actuator in communication with the controller 22. In various embodiments, the drone 12 is magnetically secured to the platform 410, as discussed in greater detail herein.

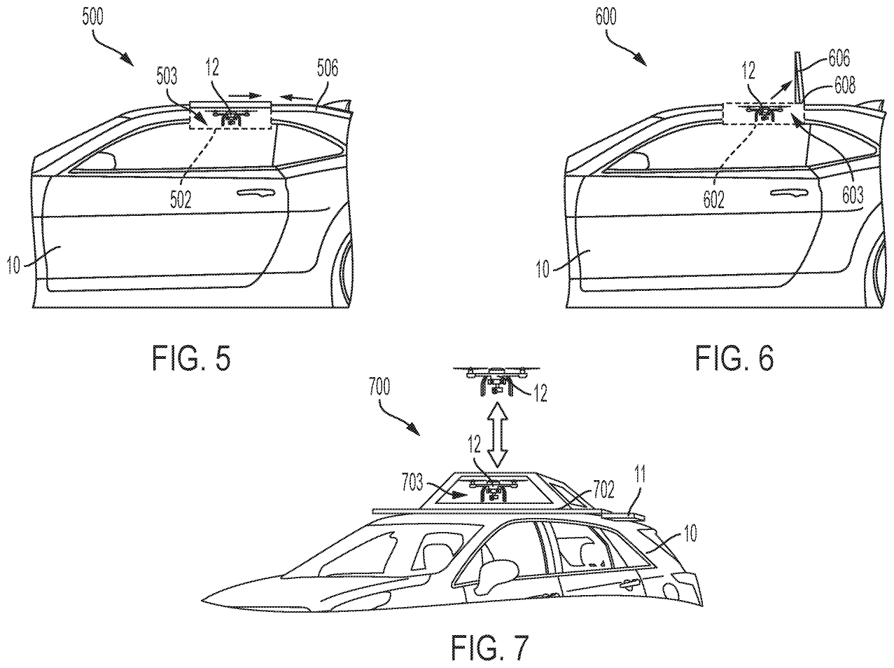

Another embodiment of a storage and deployment system 500 is illustrated in FIG. 5. The system 500 includes a storage member 502 that defines a storage volume 503 configured to store, protect, and retain the drone 12. The storage member 502 is enclosed within a roof of the vehicle 10. A cover member 506 is slidably coupled to the vehicle 10. Actuation of the cover member 506 slides the cover member 506 forward and backward longitudinally along the roof of the vehicle 10 or within a channel or other opening formed in the roof of the vehicle 10 with an action similar to the opening and closing operation of a vehicle sunroof. In various embodiments, a controller, such as the controller 22, is in communication with an actuator coupled to the cover member 506 to control and actuate the motion of the cover member 506.

Similar to the system 500 illustrated in FIG. 5, the system 600 illustrated in FIG. 6 includes a storage member 602 that defines a storage volume 603 configured to store, protect, and retain the drone 12. The storage member 602 is enclosed within the roof of the vehicle 10. A cover member 606 is rotatably coupled to the vehicle 10 and/or the storage member 602. The cover member 606 rotates about a hinge 608. Similar to the hinges 108, 208 discussed herein, in various embodiments, the hinge 608 is in communication with a controller such as the controller 22. The controller 22 generates one or more control signals to actuate the hinge 608, or an actuator coupled to the hinge 608, to rotate the cover member 606 open and closed.

In both of the embodiments shown in FIGS. 5 and 6, at least a portion of the storage members 502, 602 is configured to retain the drone 12 in a secure position when the drone 12 is not in use. The storage members 502, 602 may include magnetic, mechanical, or electrical means to secure the drone 12. Additionally, in some embodiments, at least a portion of the storage members 502, 602 is configured to charge the drone 12, such as via inductive charging. In various embodiments, the storage members 502, 602 are integrated into the vehicle roof for seamless vehicle styling.

Another embodiment of a storage and deployment system 700 is illustrated in FIG. 7. In this embodiment, a storage member 702 is coupled to a roof rack 11 of the vehicle 10 using any type of removable coupling means, such as clamps. The storage member 702 may be a rotatable cover or box, similar to the cover member 206 shown in FIG. 2. In various embodiments, a top portion of the storage member 702 may be slidable or rotatable to uncover the storage volume 703 and provide an unimpeded launch opening for the drone 12. Power may be provided to the system 700 via an external cable or other connection.

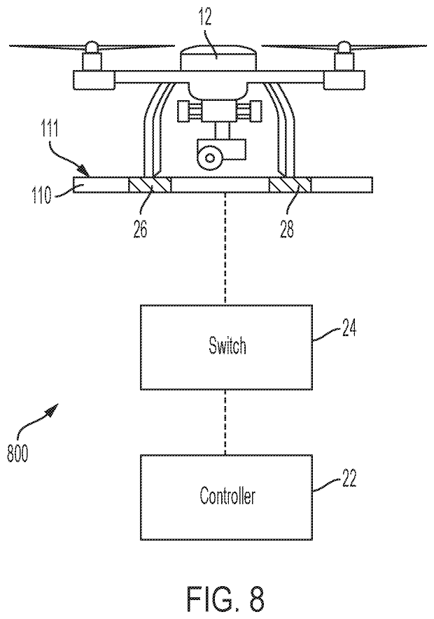

Each of the systems 100-700 discussed herein may include a retention system, such as the retention system 800 shown in FIG. 8. The retention system includes a controller 22 in communication with a switch 24. The switch 24 is in communication with members 26, 28. The members 26, 28 may be integrated into the platform, such as the platform 110, or may be separate from and coupled to the platform surface, such as the platform surface 111. In various embodiments, the members 26, 28 are rotatable magnetic latches that are switchable, via the switch 24, to actuate and hold the drone 12 in place on the platform 110 or to release the drone 12 for launch from the platform surface 111. In various embodiments, any of the platforms discussed herein may be a permanent magnetic base that is switchable from a magnetized state to a demagnetized state and vice versa to retain and release the drone 12. In various embodiments, the members 26, 28 also provide points of contact for charging the drone 12, such as via inductive charging.

Any of the systems discussed herein may be electronically controlled, either remotely or directly, by a controller, such as the controller 22. Each of the systems discussed herein may include an actuator such as a linear actuator, electric motor, etc. in communication with the controller 22 to actuate the cover member to cover or uncover the storage volume enclosing the drone. In various embodiments, each of the systems discussed herein include a dock for the drone 12 to charge the drone 12 when not in use.

In various embodiments, the cover member, the hinges, and the platform may be integrally formed with the storage member as a single unit. In some embodiments, each of the cover member, the hinges, and the platform are separately formed and coupled to the cover member and/or to each other using any type of mechanical fasteners such as nuts, screws, or bolts, or may be welded together. In various embodiments, each component of each of the systems discussed herein moves relative to one or more of the other components, such as, for example, the cover member being movable relative to the platform and vice versa, the platform being movable relative to the storage member and vice versa, and the cover member being movable relative to the storage member and vice versa.

It should be emphasized that many variations and modifications may be made to the herein-described embodiments, the elements of which are to be understood as being among other acceptable examples. All such modifications and variations are intended to be included herein within the scope of this disclosure and protected by the following claims. Moreover, any of the steps described herein can be performed simultaneously or in an order different from the steps as ordered herein. Moreover, as should be apparent, the features and attributes of the specific embodiments disclosed herein may be combined in different ways to form additional embodiments, all of which fall within the scope of the present disclosure.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

Moreover, the following terminology may have been used herein. The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item. The term “about” or “approximately” means that quantities, dimensions, sizes, formulations, parameters, shapes and other characteristics need not be exact, but may be approximated and/or larger or smaller, as desired, reflecting acceptable tolerances, conversion factors, rounding off, measurement error and the like and other factors known to those of skill in the art. The term. “substantially” means that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

A plurality of items may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. Furthermore, where the terms “and” and “or” are used in conjunction with a list of items, they are to be interpreted broadly, in that any one or more of the listed items may be used alone or in combination with other listed items. The term “alternatively” refers to selection of one of two or more alternatives, and is not intended to limit the selection to only those listed alternatives or to only one of the listed alternatives at a time, unless the context clearly indicates otherwise.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further exemplary aspects of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A system for storage and deployment of a drone from a vehicle, the system comprising:
a platform having a platform surface including a magnetic latching system configured to releasably secure the drone to the platform surface;
a storage member enclosing the platform, the storage member defining a storage volume configured to enclose the drone when the drone is secured to the platform and unenclose the platform to permit launch of the drone from the platform;
an actuator configured to move the storage member between an enclosed position and an unenclosed position; and
at least one controller in communication with the actuator, the at least one controller being configured to, in response to satisfaction of a first operating condition, control the actuator to move the storage member to the unenclosed position, and, in response to satisfaction of a second operating condition, control the actuator to move the storage member to the enclosed position.

2. The system of claim 1, wherein the platform includes an inductive charging member to inductively charge the drone when the drone is secured to the platform surface.

3. The system of claim 1, wherein the storage member includes a cover member, the actuator is coupled to the cover member, and the at least one controller is configured to, in response to satisfaction of a first operating condition, control the actuator to move the cover member to the unenclosed position, and, in response to satisfaction of a second operating condition, control the actuator to move the cover member to the enclosed position.

4. The system of claim 3 further comprising a hinge coupled to the cover member and in communication with the actuator and the cover member rotates relative to the platform.

5. The system of claim 3, wherein the cover member translates relative to the platform.

6. The system of claim 1, wherein the storage member rotates relative to the platform.

7. The system of claim 1, wherein the magnetic latching system includes a magnetic latch in communication with the at least one controller, wherein the at least one controller is configured to, in response to satisfaction of the first operating condition, control the magnetic latch to release the drone from the platform surface and, in response to satisfaction of the second operating condition, secure the drone to the platform surface.

8. The system of claim 7, wherein the first operating condition comprises a drone launching instruction received by the controller and the second operating condition comprises a drone storage instruction received by the controller.

9. A system for storage and deployment of a drone from a vehicle, the system comprising:
a platform having a platform surface including a magnetic latching system configured to releasably secure the drone to the platform surface;
a storage member enclosing the platform, the storage member defining a storage volume configured to enclose the drone when the drone is secured to the platform;
an actuator configured to move the platform relative to the storage member, the platform movable between an enclosed position and an unenclosed position; and
at least one controller in communication with the actuator, the at least one controller being configured to, in response to satisfaction of a first operating condition, control the actuator to move the platform to the unenclosed position, and, in response to satisfaction of a second operating condition, control the actuator to move the platform to the enclosed position.

10. The system of claim 9, wherein the storage member is a cylinder defining a cylindrical volume configured to enclose the drone when the drone is secured to the platform surface.

11. The system of claim 10 further comprising a cover member hingably coupled to the storage member.

12. The system of claim 10, wherein the platform is coupled to the storage member via a tether configured to unwind from the storage member to vertically extend the platform above the storage member and wind to pull the platform within the cylindrical volume of the storage member.

13. The system of claim 9 further comprising a hinge coupled to the actuator and to the platform such that the platform is rotatable about the hinge and in the unenclosed position, the platform is rotated 180 degrees from the enclosed position.

14. The system of claim 9, wherein the first operating condition comprises a drone launching instruction received by the controller and the second operating condition comprises a drone storage instruction received by the controller.

15. The system of claim 9, wherein the platform includes an inductive charging member to inductively charge the drone when the drone is secured to the platform surface.

16. The system of claim 9, wherein the magnetic latching system includes a magnetic latch in communication with the at least one controller, wherein the at least one controller is configured to, in response to satisfaction of the first operating condition, control the magnetic latch to release the drone from the platform surface and, in response to satisfaction of the second operating condition, secure the drone to the platform surface.

17. An automotive vehicle, comprising:
a vehicle body;
a storage and deployment system for an aerial drone, the system comprising
a platform having a platform surface including a magnetic latch configured to releasably secure the drone to the platform surface;
a storage member adjacent to the platform, the storage member defining a storage volume configured to enclose the drone when the drone is secured to the platform;
an actuator configured to move one of the storage member and the platform between an enclosed position and an unenclosed position;
at least one controller in communication with the actuator, the at least one controller being configured to, in response to receipt of a drone launching instruction, control the actuator to move the storage and deployment system to the unenclosed position, and, in response to receipt of a drone storage instruction, control the actuator to move the storage and deployment system to the enclosed position.

18. The automotive vehicle of claim 17, wherein moving the storage and deployment system to the unenclosed position comprises moving the storage member relative to the platform such that the platform is not enclosed by the storage member and moving the storage and deployment system to the enclosed position comprises moving the storage member relative to the platform such that the platform is enclosed by the storage member.

19. The automotive vehicle of claim 17, wherein moving the storage and deployment system to the unenclosed position comprises moving the platform relative to the storage member such that the platform is not enclosed by the storage member and moving the storage and deployment system to the enclosed position comprises moving the platform relative to the storage member such that the platform is enclosed by the storage member.

20. The automotive vehicle of claim 17, wherein the platform includes an inductive charging member to inductively charge the drone when the drone is secured to the platform surface.
